(19) United States
(12) Patent Application Publication
(10) Pub. No.: US 2006/0173934 A1
(43) Pub. Date: Aug. 3, 2006

(54) Saving documents on multiple drives

(75) Inventor: Patti F. Echtenkamp, Jackson, NE (US)

Correspondence Address: GATEWAY, INC.;ATTN: Patent Attorney, 610 GATEWAY DRIVE, MAIL DROP Y-04, N. SIOUX CITY, SD, 57049, US

(73) Assignee: Gateway

(21) Appl. No.: 11/050,622

(22) Filed: Feb. 2, 2005

(51) Int. Cl. G06F 17/30

(52) U.S. Cl. 707/204

(57) ABSTRACT

Methods apparatus and systems for simultaneously saving documents to multiple file storage locations in response to a single command. The multiple file locations may be located on separate drives.

### TECHNICAL FIELD

The subject matter relates generally to apparatus, systems, and methods used to save files to file storage locations.

### BRIEF DESCRIPTION OF THE DRAWINGS

FIG. 1 is a block diagram of an apparatus according to various embodiments;

FIG. 2 is a block diagram of an apparatus according to various embodiments; and

FIGS. 3 through 9 are flow charts illustrating several methods according to various embodiments.

### DETAILED DESCRIPTION

In the following detailed description of various embodiments, reference is made to the accompanying drawings that form a part hereof, and in which are shown by way of illustration, and not of limitation, specific embodiments in which the subject matter may be practiced. In the drawings, like numerals describe substantially similar components throughout the several views. The embodiments illustrated are described in sufficient detail to enable those skilled in the art to practice the teachings disclosed herein. Other embodiments may be utilized and derived therefrom, such that compositional, structural, and logical substitutions and changes may be made without departing from the scope of this disclosure. The following detailed description, therefore, is not to be taken in a limiting sense.

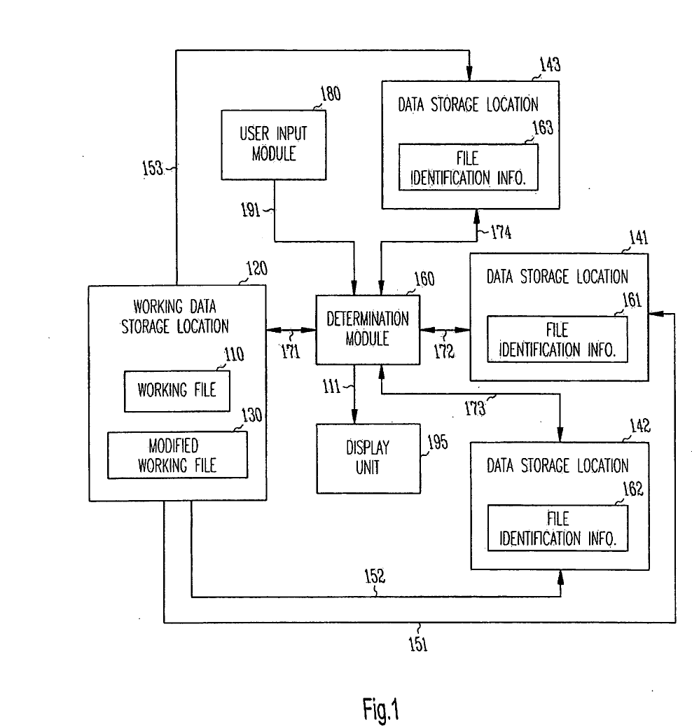

FIG. 1 is a block diagram of an embodiment that simultaneously stores a copy of a document in each of a plurality of data storage locations. The file storage locations may be located on one or more separate drives.

In one embodiment, the document is a working file 110 which is stored in a working data storage location 120. After modification, the working file 110 becomes a modified working file 130 and replaces its prior version in the working data storage location 120. Modification is an operation such as changing or otherwise processing data in the working file 110. Modification also includes saving a working file in which no changes have been made.

The modified working file 130 is saved periodically after completing the modification. The working data storage location 120 is coupled to a data storage location 141 through a pathway or connection 151 under control of a determination module 160, discussed later. In an embodiment, the connection 151 is a computer bus.

In some embodiments, there is at least one additional data storage location, and in the embodiment of FIG. 1, these are represented by data storage locations 142 and 143. Data storage locations 141, 142 and 143 are each coupled to the working data storage location 120 through a connection, here 151, 152 and 153 for data storage location 141, 142 and 143, respectively.

Modified working file 130 is saved in at least two of the plurality of data storage locations 141, 142 and 143, under control of a determination module 160. The determination module 160 is coupled to the working data storage location 120 through a connection 171, and to the data storage location 141 through the connection 172, to the data storage locations 142 and 143 through the connections 173 and 174 respectively.

An operator can designate the data storage locations for storage of the modified file by using a user input module 180. The user input module 180 is connected to the determination module 160 through a pathway 191. In one embodiment, information from the determination module 160 is provided to the operator on a display unit 195. The modified working file 130, when saved in the data storage location 141 carries associated file identification information 161 which is used to retrieve the file when required. It may also have other functionalities such as for copying, or for renaming the document.

In an embodiment, the determination module 160 is a microprocessor based module. In an embodiment, user input module 180 is a keyboard. In an embodiment, the data storage locations 141, 142 and 143 are all located within the same computer as the determination module 160.

In an embodiment, a connection 172 between the determination module 160 and the data storage location 141, and a connection 151 between the data storage location 141 and the working data storage location 120 are similar. The connection 172 carries information and control signals from determination module 160 and may also perform other functions such as addressing a memory location. The connection 151 carries data from the working storage location 120 to the data storage location 141 in addition to other functions such as carrying data in the opposite direction from the data storage location 141 to the working storage location 120. In an embodiment, the connections 172 and 151 are each a computer data bus. The types of the data storage location 141, 142, 143 are different in some embodiments. Thus, for example, in an embodiment, one data storage location 141 is a hard disk, and another data storage location 142 is a CD-RW, and yet another data storage location 143 is a Floppy Disk.

In an embodiment, the determination module 160 is a server. In another embodiment, the determination module 160 is a computer or a laptop PC or desktop PC. In an embodiment, the determination module 160 is a module on a computer or a laptop PC or desktop PC or any other similar module, as a person with common skill in the art will recognize, capable of taking decisions based on external input, say from an operator, through the user input module 180, and directing the data accordingly. In an embodiment, the user input module 180 is an optical mouse. In an embodiment, user input module 180 is a wireless keyboard. In yet another embodiment, the user module includes both a keyboard and a mouse. In an embodiment, user input module 180 is a touch screen pad or other equivalent module.

In an embodiment, each of the data storage locations 141, 142 and 143 is a part of the same equipment as the determination module 160. In an embodiment, the connection 172 between data storage locations 141 and the determination module 160, and the connection 151 between data storage location 141 and working data storage location 120, are through a network or by any other equivalent communication apparatus. In an embodiment, the coupling between the user input module 180 and the determination module 160 is through a wireless communication path 191. In an embodiment, the connection 111 between the display unit 195 and the determination module 160 is through an optical link.

In an embodiment, the connection 172 between the determination module 160 and the data storage location 141 and the connection 151 between the data storage location 141 and working data storage location 120 are similar. In yet another embodiment the connections between the determination module 160 and the data storage location 141, 142 and 143 each could be different. Thus for example, the connection 172 between determination module 160 and one data storage location 141 is a computer bus and connection 173 between determination module 160 and another data storage location 142 is through a network or internet.

In an embodiment, the data storage location 142 is within a different partition on the same hard disk as the data storage location 141.

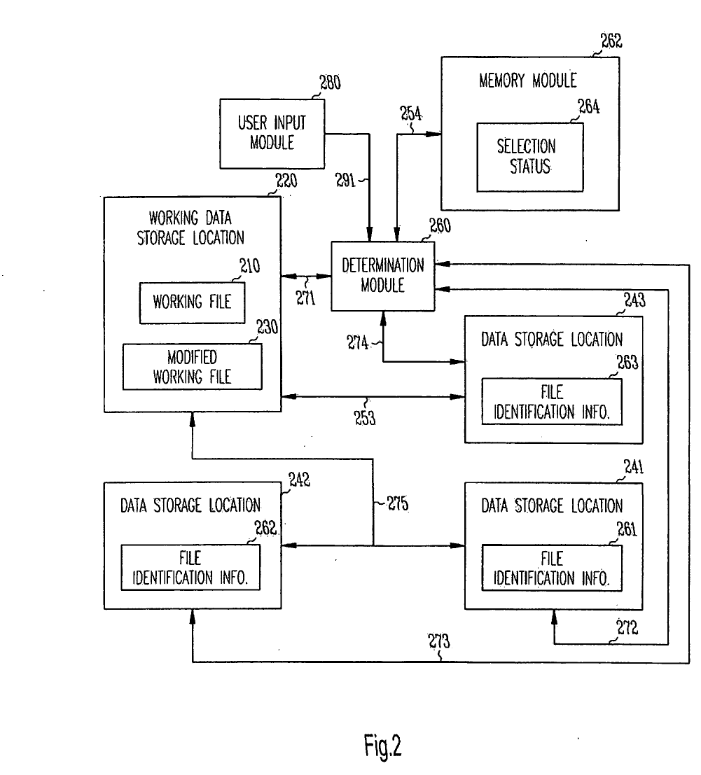

Further, in an embodiment, shown in FIG. 2, the working file 210, after modification, becomes a modified working file 230 which is in working data storage location 220, and needs to be saved repeatedly after that modification. In an embodiment, modified working file 230 is not shown separately, and as such is represented by 210 it self in working data storage location 220. The data storage locations 241 and 242 are coupled to the working data storage location 220 through connection 275. In an embodiment, the connection 275 is an energy conduit. The data storage location 243 is coupled to the working data storage location 220 through a connection 253. The connections 253 and 275 are used for transferring data from the working data storage location 220 to the other data storage locations 241, 242 and 243. A determination module 260, based on input from a user input module 280, controls movement of data from the working data storage location 220 to the plurality of data storage locations 241, 242 and 243. In the embodiment of FIG. 2, the determination module 260 has an associated memory module 262 where an indicator of a selection status 264 of selected data storage locations 241, 242 and 243, is stored. The determination module 260 is coupled to the memory module 262 through a connection 254. In an embodiment, the connection 254 is a computer bus.

The document is saved in Data Storage Location 141, 142 and 143 of the embodiment of FIG. 1 by writing the data corresponding to the modified working file 130 in a hierarchy classification on the data storage location. The hierarchy classification in an embodiment consists of a folder with a first name and a hardware module with a third name, the document to be saved is considered having a second name. In an embodiment, a hardware module is a hard disk. In an embodiment, a folder is a file folder with the first name limited to eight alphanumeric characters with certain limitations on acceptable alphanumeric characters like special characters are not acceptable.

In an embodiment, the hierarchy classification consists of a folder with the first name, a higher hierarchy file storage location with the third name and a partition on a hard disk with a fourth name. The document to be saved is considered having the second name. In an embodiment, the second name is SingleStep, the first name is Inventions, the third name is My Documents, and the fourth name is D:\. In an embodiment, the document with the name SingleStep is saved in the folder Inventions, and the folder Inventions is saved in the higher hierarchy file storage location My Documents, and the higher hierarchy file storage location is saved in the partition D:\ of the data storage location 141.

In an embodiment, a data storage location 142 is a higher hierarchy file storage location. In an embodiment, the hierarchy classification has more than one higher hierarchy file storage locations in addition to the data storage location 143. As will be recognized, this corresponds to saving the document in a folder within a folder with all of these being within yet another, higher order, folder.

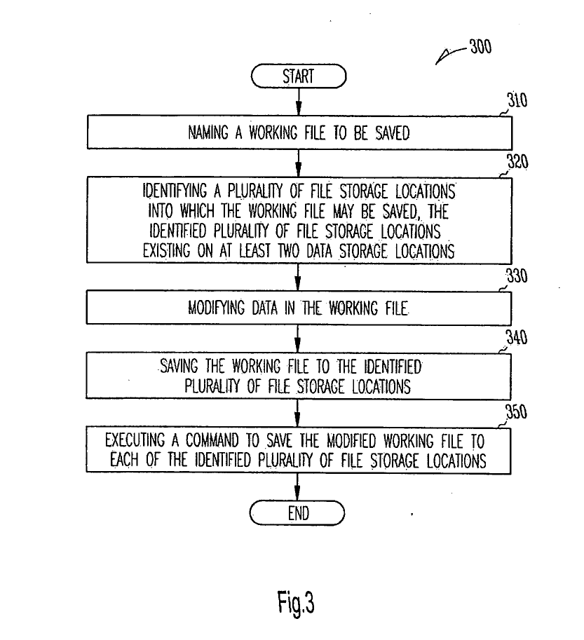

FIG. 3 represents a method flow chart 300 illustrating an embodiment of the present invention. In Block 310, a name is selected to designate a working file 110 to be saved. Further, 320 represents designating a plurality of file storage locations into which the working file may be saved. In some embodiments the identified plurality of file storage locations is not located on the same data storage location 141 or 142 or 143 of, for example, the embodiment of FIG. 1. Instead, the identified plurality of file storage locations is located on at least two of the data storage locations 141, 142, and 143 of FIG. 1. In an embodiment, a second plurality of file storage locations is the data storage location 142. In an embodiment, the identified plurality of file storage locations are folders with a same name on at least two data storage locations 141 and 142. In an embodiment, the second plurality of file storage locations is a hard disk. Further to identifying the plurality of file storage locations, 330 represents modifying data in the working file 110. In an embodiment, block 330 is carrying out required operations on the data. Further, 340 represents saving the modified working file 130 of the embodiment of FIG. 1, to the identified plurality of file storage locations. In one embodiment, block 340 corresponds to selecting the option ‘save as’. In an embodiment, this is done by moving a mouse and pointing a cursor at a ‘File’ icon, clicking the left button on the mouse to get a drop down menu, moving the mouse again to point the cursor at ‘Save as’ option and left clicking the mouse again. Further, block 350 represents executing a command to save the modified working file 130 to each of the identified plurality of file storage locations.

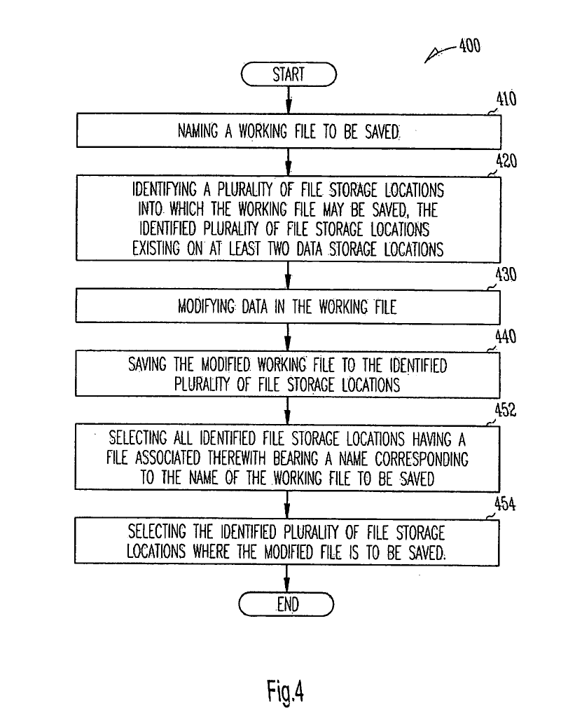

In the method Flow Chart 400 shown in FIG. 4, block 452 corresponds to selecting all identified file storage locations having a file associated therewith bearing a name corresponding to the name of the working file to be saved. Further, as shown in FIG. 4 at 454, then selecting the plurality of the identified file storage locations where the modified file is to be saved.

In an embodiment, another block is required wherein the mouse is moved to point the cursor to a ‘Save’ icon and then left clicking the ‘Save’ icon to save the modified working file to each of the identified plurality of file storage locations where the modified file is to be saved from the list of plurality of selected file storage locations.

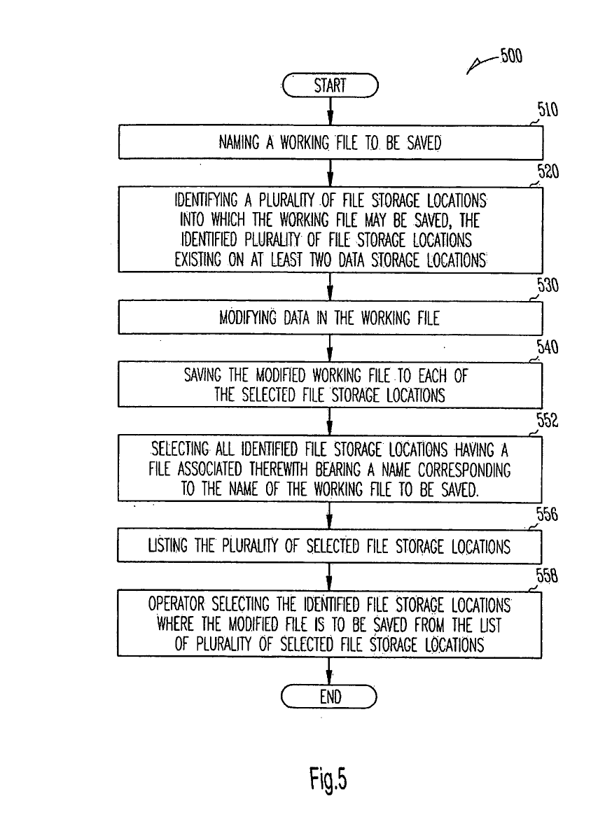

In an embodiment, the method flow chart 500 represented in FIG. 5 includes selecting all identified file storage locations in block 552, and listing a plurality of selected file storage locations as shown at 556. This is done, in the embodiment of FIG. 1, by providing a list on the display module 195. As shown in 558, an operator then selects the identified plurality of file storage locations where the modified file is to be saved from the list of plurality of selected file storage locations using the user input terminal 180 of the embodiment of FIG. 1.

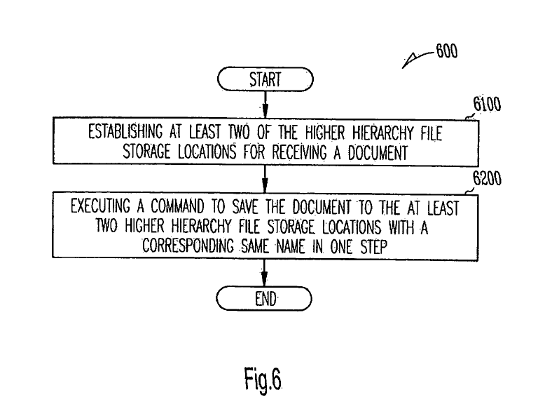

In an embodiment, the method flow chart 600 of FIG. 6, block 6100 represents establishing at least two of the higher hierarchy file storage locations for receiving a document. Further, 6200 represents executing a command to save the document to the at least two higher hierarchy file storage locations with a corresponding name in one step.

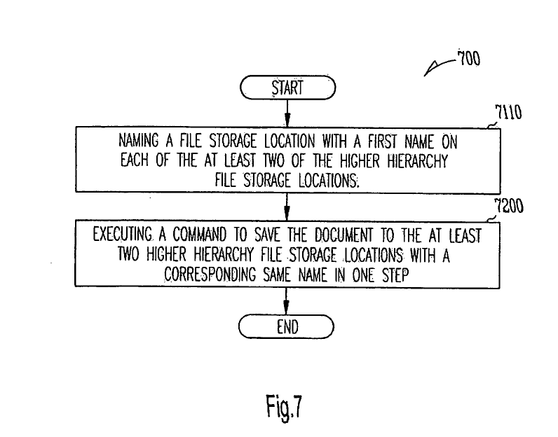

In FIG. 7, the method flow chart 700, block 7110 represents naming a file storage location with a first name on each of the at least two of the higher hierarchy file storage locations. In this figure, 7200 represents executing a command to save the document to the at least two higher hierarchy file storage locations with a corresponding same name.

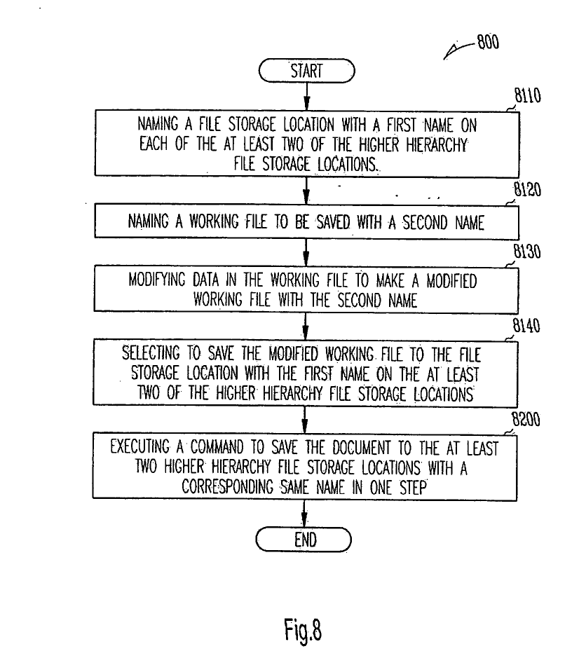

The method flow chart 800, presented in FIG. 8, in an embodiment, includes naming a file storage location with a first name on each of the at least two of the higher hierarchy file storage locations, as disclosed in 8110. In 8120, naming a working file 110 of the embodiment of FIG. 1, to be saved with a second name, is disclosed. Block 8130 represents modifying data in the working file to make a modified working file 130 of the embodiment of FIG. 1, with the second name. Further to 8130, selecting to save the modified working file to the file storage location with the first name on the at least two of the higher hierarchy file storage locations is represented by 8140. As disclosed in 8200, further to 8140, a command is executed to save the document to the at least two higher hierarchy file storage locations with a corresponding same name in one step.

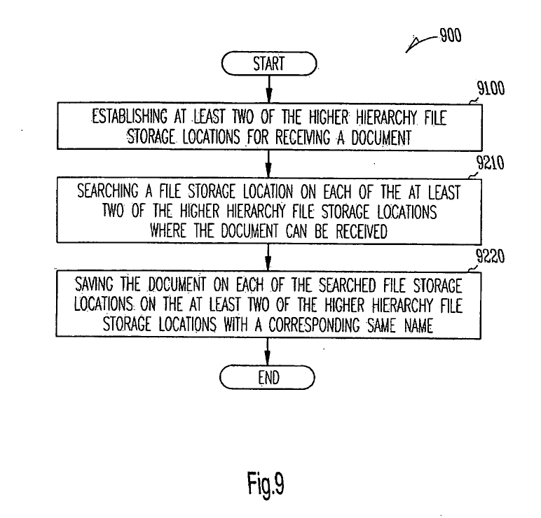

As disclosed in the method flow chart 900 of FIG. 9, in an embodiment, 9100 describes establishing at least two of the higher hierarchy file storage locations for receiving a document. Further, 9210 describes searching a file storage location on each of the at least two of the higher hierarchy file storage locations where the document can be received. As represented by 9220, the document is saved on each of the searched file storage locations on the at least two of the higher hierarchy file storage locations with a corresponding same name. In an embodiment, 9210 and 9220 are done in one step.

It should be noted that the methods described herein do not have to be executed in the order described, or in any particular order. Moreover, various activities described with respect to the methods identified herein can be executed in serial or parallel fashion.

When the term “simultaneously” is used herein regarding various computer operations it means that the operations occur at about the same time. Such operations are initiated in some embodiments with a single command, such as a mouse-click or key-stroke.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. It is to be understood that the above description has been made in an illustrative fashion, and not a restrictive one. Combinations of the above embodiments, and other embodiments not specifically described herein will be apparent to those of skill in the art upon reviewing the above description. Thus, the scope of various embodiments includes any other applications in which the above compositions, structures, and methods are used.

It is emphasized that the Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment. In the appended claims, the terms “including” and “in which” are used as the plain-English equivalents of the respective terms “comprising” and “wherein,” respectively. Moreover, the terms “first,” “second,” and “third,” etc. are used merely as labels, and are not intended to impose numerical requirements on their objects.

What is claimed is:

1. A method for saving documents to multiple file storage locations, comprising:
designating a working file to be saved;
designating a plurality of file storage locations into which the working file may be saved;
modifying data in the working file; and
simultaneously saving the working file to each file storage location in the designated plurality of file storage locations.

2. The method of claim 1, wherein saving the working file comprises:
designating all file storage locations having a file associated therewith bearing a name corresponding to the name of the working file to be saved; and
designating those file storage locations of the identified plurality of file storage locations where the modified file is to be saved.

3. The method of claim 2, wherein designating those file storage locations of the identified plurality of file storage locations where the modified file is to be saved is performed by an operator who selects the identified plurality of file storage locations for modified files from a list of the plurality of file storage locations.

4. A method for saving documents to a plurality of hierarchy of file storage locations, comprising:
establishing at least two higher hierarchy file storage locations for receiving a document; and
saving the document to the at least two higher hierarchy file storage locations with a corresponding name in a single step.

5. The method of claim 4, wherein establishing at least two higher hierarchy file storage locations comprises:
assigning a name to a file storage location within each of the higher hierarchy file storage locations.

6. The method of claim 5, wherein establishing at least two higher hierarchy file storage locations also comprises:
assigning a further name to a working file to be saved;
modifying the working file to create a modified working file with the further name; and
selecting at least two of the higher hierarchy file storage locations to receive the modified working file with the further name.

7. The method of claim 4, wherein saving the document comprises:
selecting those file storage locations of the plurality of higher hierarchy file storage locations which are to receive the document; and
simultaneously saving the document to the selected file storage locations.

8. The method of claim 4, wherein the plurality of higher hierarchy file storage locations are on two hard disks.

9. The method of claim 4, wherein the plurality of higher hierarchy file storage locations are on at least one hard disk and at least one CD-RW.

10. The method of claim 4, wherein the plurality of higher hierarchy file storage locations are on at least two partitions on a hard disk.

11. An article including a machine accessible medium having associated information thereon, wherein the information, when accessed, results in the machine performing:
naming a working file to be saved;
identifying a plurality of file storage locations into which the file may be saved;
modifying the working file; and
saving the modified working file to the plurality of file storage locations in response to a single command.

12. The article of claim 11, wherein the single command comprises:
selecting all file storage locations associated with a file bearing a name corresponding to the name of the working file to be saved; and
selecting those file storage locations of the plurality of file storage locations where the working file is to be saved.

13. The article of claim 12 wherein selecting those file storage locations of the plurality of file storage locations where the working file is to be saved is performed by an operator who selects the identified plurality of file storage locations for modified files from the list of all file storage locations associated with the file bearing the name corresponding to the name of the working file to be saved.

14. A system, comprising:
a determination module to determine whether at least two data storage locations have file identification information associated therewith corresponding to a file residing in a working data storage location and sending updated information relating to the modified file to each of the at least two data storage locations; and
an energy conduit to couple the working data storage location and the at least two data storage locations.

15. The system of claim 14, further including:
a memory coupled to the determination module to store a selection status of the at least two data storage locations.

16. The system of claim 14, further including:
a user input module to couple to the determination module to provide selection information to the determination module from a use.

17. An apparatus, comprising:
a determination module to determine whether at least two data storage locations have file identification information associated therewith corresponding to a file residing in a working data storage location and to send information relating to the modified file to each of the at least two data storage locations.

18. The apparatus of claim 17, wherein the at least two data storage locations are located within at least two partitions on a hard disk.

19. The apparatus of claim 17, wherein one of the at least two data storage locations are located on at least one CD-RW and a hard disk accessible within a network.

20. The apparatus of claim 17, wherein each of the at least two data storage locations are located on different hard disks accessible within a network.
